(19) United States
(12) Patent Application Publication
(10) Pub. No.: US 2024/0399520 A1
(43) Pub. Date: Dec. 5, 2024

(54) SORTING METHOD, SORTING DEVICE, AND ARRANGEMENT WITH SORTING DEVICE

(71) Applicant: TRUMPF Werkzeugmaschinen SE + Co. KG, Ditzingen (DE)

(72) Inventors: Nikola Bursac, Hamburg (DE); Tim Gottschalk, Leonberg (DE); Harald Mathias, Boennigheim (DE); Magnus Deiss, Stuttgart (DE)

(21) Appl. No.: 18/806,872

(22) Filed: Aug. 16, 2024

Related U.S. Application Data
(63) Continuation of application No. PCT/EP2023/051183, filed on Jan. 19, 2023.

(30) Foreign Application Priority Data
Feb. 18, 2022 (DE) 10 2022 103 891.2

(51) Int. Cl. B23Q 7/12

(52) U.S. Cl. CPC B23Q 7/12

(57) ABSTRACT

A sorting method automatically sorts workpieces produced in a flatbed machine tool according to a scheduled sorting process by a sorting device. The method includes: providing at least one piece of process information created as a result of manufacturing of the workpieces; analyzing the at least one piece of process information, such that it is determined whether there is a sorting disruption; and upon determining that there is the sorting disruption, automatically modifying the sorting process.

### CROSS REFERENCE TO RELATED APPLICATIONS

This application is a continuation of International Application No. PCT/EP2023/051183 (WO 2023/156121 A1), filed on Jan. 19, 2023, and claims benefit to German Patent Application No. DE 10 2022 103 891.2, filed on Feb. 18, 2022. The aforementioned applications are hereby incorporated by reference herein

### FIELD

The present disclosure relates to a sorting method for automatically sorting workpieces produced in a flatbed machine tool, in particular a laser cutting machine or a punching machine, according to a scheduled sorting process by a sorting device. The present disclosure also relates to a sorting device and an arrangement with the flatbed machine tool and the sorting device.

### BACKGROUND

In a sorting method, the workpieces are usually first produced from a raw material, such as sheet metal, by the flatbed machine tool and positioned in a removal area. The sorting device then automatically removes the workpieces from the removal area in a sequence specified by the sorting process and places them in a deposit area provided for the workpieces. To speed up the sorting operation, the sorting process comprises, for example, information about the number of workpieces to be sorted and their target position in the removal area. The sorting method is usually unchangeable in conventional sorting methods, as it is automatically created when a manufacturing schedule for manufacturing the workpieces in the flatbed machine tool is created, for example. This type of sorting method is used, for example, by the “Sort Master” sorting device by Trumpf & Co. KG (<<www.trumpf.com/de_DE/produkte/maschinen-GmbH systeme/automatisierung/automatisierung-fuer-2d-laserschneidmaschinen/sortmaster/>>).

However, if events occur during the manufacture of the workpieces that can disrupt or impair the sorting process, the scheduled sorting process can often not be adhered to. For example, as a result of a collision between a tool of the flatbed machine tool and the sheet metal, a workpiece can be displaced, which then has a different position compared to the target position of the sorting process and can only be removed with difficulty or not at all by the sorting device.

In the usual methods for automated sorting, the removal attempt is repeated by the sorting device as standard, which can lead to further displacement of the workpiece and/or the other workpieces. In addition, the workpieces may tilt and/or cant, which can mean that no more workpieces can be removed. This has a particularly negative effect on process reliability and the process speed of automatic sorting. In addition, in these cases a skilled worker often has to be called in to manually sort the workpieces. This also reduces the degree of automation of the sorting method.

WO 2007/124765 A1 discloses a laser processing machine with a thermo-sensitive monitoring sensor system and a method in which a faulty cut is recognized by measuring a temperature increase in an optical component of the laser processing machine.

Another method for recognizing a faulty cut is described in WO 2008/151838 A1, in which process light is detected in the sheet material during a separation process.

### SUMMARY

In an embodiment, the present disclosure provides a sorting method that automatically sorts workpieces produced in a flatbed machine tool according to a scheduled sorting process by a sorting device. The method includes: providing at least one piece of process information created as a result of manufacturing of the workpieces; analyzing the at least one piece of process information, such that it is determined whether there is a sorting disruption; and upon determining that there is the sorting disruption, automatically modifying the sorting process.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a perspective view of an arrangement with a flatbed machine tool and a sorting device according to aspects of the present disclosure;

FIG. 2 shows the method according to aspects of the present disclosure in a schematic flow chart;

FIG. 3 shows an exemplary removal area, with exemplarily arranged workpieces to explain process information;

FIG. 4 shows an example of a scheduled sorting process; and

FIG. 5 shows an example of a modified sorting process.

### DETAILED DESCRIPTION

Aspects of the present disclosure are directed to increasing process reliability, process speed, and the degree of automation for automatic sorting.

An aspect of the present disclosure provides a sorting method for automatically sorting workpieces produced in a flatbed machine tool, in particular a laser cutting machine or a punching machine, according to a scheduled sorting process by a sorting device; characterized by the steps of:
providing at least one piece of process information created as a result of manufacturing of the workpieces;
analyzing the at least one piece of process information, wherein it is determined whether there is a sorting disruption;
wherein the sorting process is automatically modified when a sorting disruption is determined.

The process information according to the present disclosure is created as a result of the production of the workpieces, in particular by the flatbed machine tool. In other words, the creation of the process information is causally related to the manufacture of the workpieces. Process information can, for example, comprise information on a position of the workpieces, a distance of the tool from the workpieces, a state of the tool or a method sequence.

In a preferred implementation form, the process information is only analyzed, in particular only created, if an event that deviates from the usual manufacturing process occurs during the manufacture of the workpieces. In this case, the process information preferably also comprises error information, in particular with regard to “tool misbehaviour”, “undershooting of a minimum distance to the workpieces” and/or “tool defect”. This can reduce the amount of process information to be analyzed and can increase the process speed.

A sorting disruption is understood here (and in the following) as an impairment of the sorting process. Sorting disruptions therefore include circumstances that occur that impede or prevent sorting according to the scheduled sorting process. A sorting disruption can occur, for example, if a workpiece to be sorted is missing, if the workpiece is not completely detached, if the workpiece is incorrectly cut, and/or if the workpiece is tilted.

According to the present disclosure, the sorting disruption can be determined by analyzing the process information. In other words, a sorting disruption is characterized by one or more predetermined pieces of process information. The process information is preferably analyzed by a controller of the sorting device.

The sorting disruption preferably has different degrees of disruption. Degrees of disruption can, for example, be low, medium, and/or high, wherein the degree of disruption is related to the impairment of sorting that occurs. For example, a slight contact between the tool and a workpiece can cause only a slight displacement and therefore a slight impairment of the sorting, wherein the workpiece can be sorted despite the impairment.

According to an aspect of the present disclosure, the sorting process is automatically modified when a sorting disruption is detected, whereby further impairments can be avoided. The sorting process is to be understood here (and in the following) as a sequence flow of the sorting operation and can, for example, have a number, a sequence, and/or a position of the workpieces to be removed as well as a direction of access of the sorting device to the workpieces to be removed.

The sorting process can be carried out, for example, by readjusting a gripper position when removing a workpiece and/or by modifying the sequence in which the workpieces are removed.

The present disclosure can therefore prevent a loss of time, and thus, productivity, for example due to a failed attempt to remove a displaced workpiece, or increase process reliability and process speed. In addition, the error-induced adaptation of the sorting process in accordance with the present disclosure, for example by omitting components that have not been fully cut, can significantly increase process reliability during sorting.

In a preferred embodiment of the sorting method, the process information is provided by a monitoring sensor system of the flatbed machine tool and transmitted to a controller of the sorting device. The monitoring sensor system is preferably a process sensor system of the flatbed machine tool, which is set up to monitor the production of the workpieces. The monitoring sensor system can be a sensor system for capacitive control of the distance of a tool of the flatbed machine tool from the workpieces and/or a sensor system for checking the tool quality. For example, it is possible that the flatbed machine tool is designed as a laser cutting machine, wherein a sensor system that is already required for the cutting process to monitor the laser beam and/or the process information to monitor the laser beam cut is used as the monitoring sensor system. This means that the existing monitoring sensors can be used particularly effectively to support the sorting process.

In a preferred embodiment of the sorting method, it is provided that the process information is assigned to at least one workpiece and a sorting disruption determined from this process information is assigned to the same workpiece. Preferably, the sorting disruption is assigned to each workpiece for which an impairment of the sorting process is likely due to the determined sorting disruption. This allows the sorting process to be adapted particularly advantageously for the affected workpieces.

In a preferred embodiment of the sorting method, a workpiece is removed from the sorting process as a result of the detected sorting disruption. For example, an incorrectly cut and/or a missing workpiece can be excluded from the sorting process, effectively avoiding unsuccessful removal attempts by the sorting device.

In a further preferred embodiment of the sorting method, each workpiece is assigned a specific disruption probability as a result of the detected sorting disruption. The disruption probability indicates the probability that the workpiece will be unsuccessfully removed by the sorting device. The successful removal of the workpiece decreases as the probability of disruption increases. This allows the workpieces to be prioritized in the sorting process, which has a particularly positive effect on the process speed and process reliability.

Preferably, the probability of disruption is dependent on the degree of disruption of the sorting disruption. It is also preferable that a sorting disruption determined for one workpiece can influence the disruption probability of the other workpieces. For example, in the event of a collision between the tool and an individual workpiece, it can be assumed that the other workpieces are at least slightly displaced and a low to medium probability of disruption can be assigned to each workpiece to be removed.

It is also preferable for the sorting disruption to be localized. For example, an individual workpiece to be removed can be assigned a high disruption probability if the workpiece is not sufficiently finished and the other workpieces to be removed can be assigned a low or no disruption probability. This makes the sorting process even more reliable.

In a preferred development of the sorting method, a workpiece is assigned a higher disruption probability with an increasing number of sorting disruptions determined for this workpiece. The disruption probabilities of different sorting disruptions can be cumulated. This allows a particularly accurate prediction to be made for the successful removal of the workpieces.

In addition, a development of the sorting method is preferred in which a sorting sequence of the sorting process is modified, wherein the workpieces are sorted according to the size of the determined disruption probabilities of the workpieces. The workpieces are sorted in the sorting process on the basis of the value of the assigned disruption probability, and are sorted by the sorting device with a decreasing probability of successful removal. This can minimize disruption with the other workpieces to be removed when a workpiece is removed, thereby increasing the process speed and process reliability. In addition, non-sortable workpieces can be removed together at the end of the sorting process without interrupting the sorting process, which further improves the process speed of the sorting method.

In a preferred embodiment of the sorting method, the process information is in the form of a workpiece position, a tool distance to the workpieces, a tool state and/or a method course. In particular, the process information is in the form of error information. The inventors have found that this can increase process reliability to a particularly high degree, since the process information described is particularly significant with regard to sorting disruptions that occur.

Another preferred embodiment of the sorting method is one in which an image of a removal area of the flatbed machine tool is created and used to evaluate the process information. This allows the presence of a sorting disruption, a degree of disruption of the sorting disruption and/or the workpieces affected by the sorting disruption to be determined particularly effectively.

Alternatively or additionally, a sorting disruption that occurs when positioning the workpieces in the removal area can be recognized by taking the image of the removal area into account when evaluating the process information. If, for example, a displacement of a workpiece is detected in the image of the removal area that is not causally attributable to the process information, this can still be taken into account. This makes sorting even faster and more reliable.

In a preferred development of the sorting method, an image information is determined from the image of the removal area and compared with the process information, wherein a position specification of the workpieces, a design of the workpieces and/or a number of the workpieces is determined from the image information. In other words, the process information can be compared with equivalent image information, whereby a sorting disruption, the degree of disruption of the sorting disruption and/or the workpieces affected by the sorting disruption can be determined even more effectively.

A development of the sorting method is particularly preferred, in which an offset between a position specification of the workpieces is determined from the image and a position specification of the workpieces is determined from the process information and a sorting disruption is determined when a predetermined offset limit value is exceeded. An absolute offset of the workpieces can be determined. The inventors have determined that an absolute offset of the workpieces is of great importance for the successful removal of all workpieces. It can therefore be provided that automatic sorting is cancelled by the sorting device if the predetermined offset limit value is exceeded.

The offset limit value is preferably dependent on the material thickness of the workpieces to be removed. For example, it may be provided that the offset limit value is at most seven millimetres, in particular at most five millimetres, if the workpieces have a material thickness of less than four millimetres, in particular less than two point five millimetres.

Another preferred embodiment of the sorting method is one in which a sorting disruption is detected in the form of an incorrect cut, tilting and/or displacement of the workpieces. These sorting disruptions have a significant adverse effect on the sorting process.

Aspects of the present disclosure provide a sorting device for automatically sorting workpieces produced in a flatbed machine tool according to a sorting process, in particular set up for carrying out the sorting method described above, having a controller for controlling a gripper of the sorting device, wherein the gripper is designed to grip the workpieces; characterized in that the controller is set up to evaluate process information provided and to determine a sorting disruption; wherein the controller is set up to automatically modify the sorting process when a sorting disruption is determined.

The controller preferably has an evaluation unit and a memory unit. The scheduled sorting process is preferably stored in the memory unit of the controller. The evaluation unit preferably has means for evaluating the process information and/or the image of the removal area. For example, the evaluation unit may have means for data comparison and/or image analysis. Furthermore, it may be provided that the evaluation unit has a neural network for evaluating the process information, wherein the neural network has been trained using thousands of pieces of process information and their correspondingly assigned sorting disruptions.

In a preferred embodiment of the sorting device, the latter comprises an imaging means (imager) for creating an image of a removal area in which the workpieces are positioned for sorting; wherein the controller is set up to determine image information from the image and to determine a sorting disruption by means of the image information.

Preferably, the imaging means (imager) is designed for photographic and/or sensor-based imaging of the removal area. For example, the imaging means can take the form of a camera and/or a laser scanner. This allows the removal area to be imaged particularly quickly and comprehensively.

The imaging means is also preferably arranged above the removal area and directed in a predominantly vertical direction towards the removal area. This ensures that the imaging of the removal area is as unobstructed as possible.

An aspect of the present disclosure provides an arrangement comprising a flatbed machine tool, in particular a laser cutting machine or punching machine, and a sorting device, in particular as described above, wherein the flatbed machine tool is designed to produce workpieces and to position the workpieces in the removal area; wherein the sorting device is designed and set up to sort the workpieces positioned in the removal area after the sorting process. According to an aspect of the present disclosure, the flatbed machine tool is set up to provide the process information and the sorting device has a controller which is set up to evaluate the process information, to determine a sorting disruption from the process information and to automatically modify the sorting process when a sorting disruption is determined.

In a preferred embodiment of the arrangement, the flatbed machine tool has a monitoring sensor system that is designed to determine the process information and to transmit the process information to the control system of the sorting device. This allows the process information to be provided particularly quickly and directly. Preferably, the flatbed machine tool is set up to automatically transmit the process information. This can further increase the degree of automation.

Further features and advantages of the present disclosure can be found the description, the claims and the drawing. According to the present disclosure, the features mentioned above and those still to be further presented can be used in each case individually or together in any desired expedient combinations. The embodiments shown and described should not be understood as an exhaustive enumeration, but rather are of an exemplary character for illustrating aspects of the present disclosure.

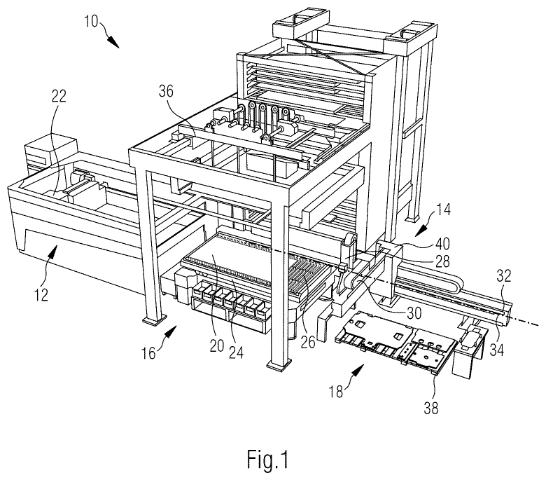

FIG. 1 shows an arrangement 10 with a flatbed machine tool 12 in the form of a laser cutting machine, a sorting device 14, a removal area 16 and a deposit area 18.

The exemplary flatbed machine tool 12 is designed to produce workpieces 20 according to a production schedule. To monitor the production of the workpieces 20, the flatbed machine tool 12 has a monitoring sensor system 22. The monitoring sensor system 22 can have several measuring means that are set up to measure various process variables during the production of the workpieces 20. For example, a distance measurement between a processing head of the laser cutting machine and/or a measurement of the cutting quality can be performed. In addition, the features described here can be transferred to a punching machine analogously.

As shown in FIG. 1, the workpieces 20 previously produced in the flatbed machine tool 12 are positioned on a workpiece support 24 in the removal area 16. The workpiece support 24 has a bar support 26.

The exemplary sorting device 14 has a gripper 28, which is arranged movably on a cantilever arm 30 and is movable by means of a rail guide 32 along an axis 34 between the removal area 16 and the deposit area 18. The gripper 28 can be moved translationally and rotationally relative to the cantilever arm 30.

Above the removal area 16, an imaging means (imager) 36 of the sorting device 14 in the form of a camera can be attached. The imaging means 36 is in this case oriented vertically downwards onto the removal area 16 and is set up for imaging the whole of the latter.

A deposit pallet 38 is positioned in the deposit area 18 and is used for depositing and further transporting the workpieces 20.

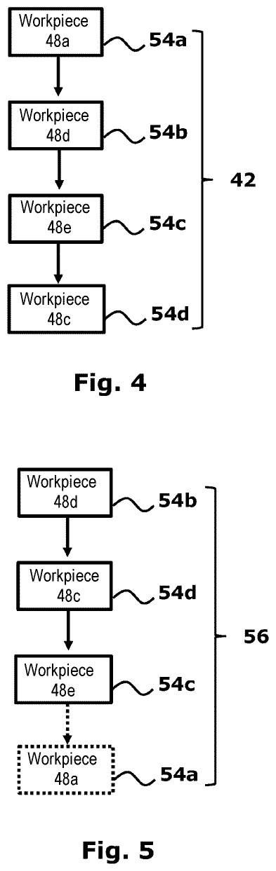

To sort the workpieces 20, the gripper 28 is moved for example according to a scheduled sorting process 42 stored in a controller 40 of the sorting device 14 (see FIG. 4) until the workpieces 20 have been removed from the removal area 16 and deposited in the deposit area 18. The gripper 28 moves, for example, along the axis 34 over the removal area 16 and is deflected in a vertical direction up to the workpieces 20. The gripper 28 then grips one of the workpieces 20, for example, and is then moved upwards in a vertical direction. The gripper 28 is then moved along the axis 34 into the deposit area 18 and deflected there in the same way in order to deposit the picked-up workpiece 20.

The scheduled sorting process 42 is stored in the controller 40 before sorting begins, for example manually, and can subsequently be modified by the controller 40, in particular also during the sorting process. Preferably, the scheduled sorting process 42 is created when a production schedule of the flatbed machine tool 12 is created and is automatically stored by the flatbed machine tool 12.

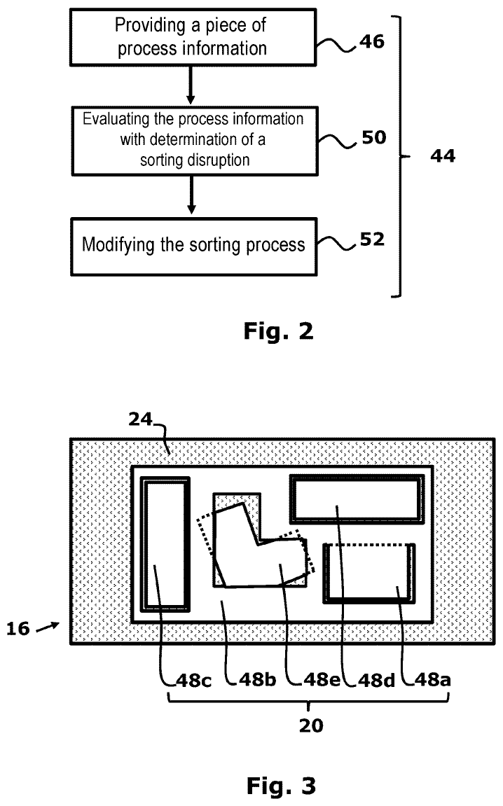

FIG. 2 shows a schematic representation of a sorting method 44 according to the present disclosure, which, with reference to the remaining FIGS. 1, 3, 4 and 5 will be explained by way of example.

In a method step “providing process information” 46, process information is provided that was created as a result of the production of the workpieces 20. The process information is generated, for example, by the monitoring sensor system 22 (see FIG. 1) during the cutting of a metal sheet by a laser beam of the laser cutting machine. The process information is preferably only created if an event occurs during the manufacturing process that does not occur and/or is not intended to occur in the normal manufacturing process.

For example, a tool of the flatbed machine tool 12 can come into contact with a workpiece 20. The monitoring sensor system 22 can generate process information on the tool spacing. In addition, contact is not intended in the normal manufacturing process and the error information “minimum distance not reached” or “collision” can be created. The process information, in particular the error information, preferably comprises partial information that makes it possible to determine the position of the process information, for example.

Furthermore, for example, a workpiece 20 may have been incompletely separated from the other workpieces 20 due to incorrect production settings and/or a machine defect. The faulty production settings can be recognized by the flatbed machine tool 12 and used to generate process information, in particular disruption information, on the tool state.

A schematic representation of these and other events is shown, for example, in FIG. 3, which shows the removal area 16 with exemplary workpieces 20 positioned and arranged on the workpiece support 24. A workpiece 48a is only incompletely separated from a remaining grid designated as workpiece 48b. A workpiece 48c and a workpiece 48d are properly manufactured. A workpiece 48c is displaced in its position and twisted under the remaining grid 48b. The inadequate production of the workpiece 48a can, for example, be attributed to a tool defect that was recognized and rectified during production. For example, the workpiece 48e may have been displaced and twisted by a collision with the tool of the flatbed machine tool 12 (see FIG. 1).

The process information provided in accordance with method step 46 is preferably transmitted automatically by the flatbed machine tool 12. This can further improve the degree of automation.

In a subsequent method step “evaluating the process information with determination of a sorting disruption” 50, the process information is evaluated, wherein a possible sorting disruption is recognized. Here, the process information is analyzed in the controller 40 (see FIG. 1) and compared with stored reference information that is assigned to predetermined sorting disruptions. For example, in the case of a laser cutting machine, a sorting disruption can be determined if the process information is provided in the form of the disruption information “breakage of the laser beam” and a comparison with the reference information shows that the “breakage of the laser beam” represents insufficient detachment of the workpiece 20 from the other workpieces 20, as a result of which the workpiece 20 cannot be removed.

In a further method step “modifying the sorting process” 52, the scheduled sorting process 42 (see FIG. 4) is modified as a result of the determined sorting disruption.

According to the exemplary design of the workpieces 20 in FIG. 3, a planned sorting process 42 can be shown schematically, for example as in FIG. 4. According to the scheduled sorting process 42, it can be provided, for example, that the sorting steps 54a-d are carried out in sequence, starting with the sorting step 54a. According to FIG. 4, the workpiece 48a is sorted first, followed by the workpieces 48d and 48e and lastly the workpiece 48c. However, as the workpieces 48a and 48e are difficult or impossible to remove from the removal area 16 (see FIG. 3), there are considerable delays and the sorting process may be cancelled.

An exemplary modified sorting process 56 of the scheduled sorting process 42 shown in FIG. 4 is shown in FIG. 5. As shown, the modified sorting process 56 now has the sequence 54b-54d-54c for the sorting steps 54b-d. The sorting step 54a has been removed from the modified sorting process 56, as the workpiece 48a cannot be removed. The properly manufactured workpieces 48c and 48d were prioritized for removal, as no further impairment of the other workpieces 48c and 48e is to be expected when they are removed. The workpiece 48c, which is difficult to remove, was placed at the end of the modified sorting process 56 so that possible shifts during removal, for example due to the remaining grid, cannot have any effect on the other workpieces 20 to be removed.

According to the example, the sorting process 56 was thus modified by modifying the order in which the workpieces are removed and by removing a workpiece from the sorting process. In other words, the scheduled sorting process 42 was updated by the controller 40.

Preferably, a disruption probability determined for the workpieces 20 in method step 50 is taken into account when modifying the scheduled sorting process 42. For example, it may be provided that the workpiece 48a is assigned the disruption probability with a value of 100 percent on the basis of the sorting disruption affecting this workpiece 48a.

Furthermore, for example, a disruption probability of 80 percent can be assigned to workpiece 48e due to the sorting disruption “collision with workpiece”. Since the collision of the tool can also have an effect on the disruption probability of the other workpieces 20, the workpieces 48c and 48d, for example, can be assigned a disruption probability with a value of 10 percent. The disruption probability is also preferably dependent on the degree of disruption of the sorting disruption. Thus, it can be provided that the workpiece 20 (here workpiece 48e) and/or the other workpieces 20 are assigned a high disruption probability in the event of significant contact between the tool and a workpiece 20 and a low disruption probability in the event of slight contact.

The modified sorting process 56 thus exhibits, for example, an increasing probability of disruption with the workpieces 20 to be removed for the sequence of the sorting steps 54a-d.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

10 arrangement;
12 flatbed machine tool;
14 sorting device;
16 removal area;
18 deposit area;
20 workpiece;
22 monitoring sensor system of the flatbed machine tool 12;
24 workpiece support;
26 bar support of the workpiece support 24;
28 gripper of the sorting device 14;
30 cantilever arm of the sorting device 14;
32 rail guide of the sorting device 14;
34 axis of the rail guide 32;
36 imaging means of the sorting device 14;
38 deposit pallet;
40 controller of the sorting device 14;
42 scheduled sorting process;
44 sorting method;
46 method step “providing process information”;
48a-e workpieces;
50 method step “evaluating process information”;
52 method step “modifying the sorting process”;
54a-d sorting step;
56 modified sorting process.

1. A sorting method for automatically sorting workpieces produced in a flatbed machine tool according to a scheduled sorting process by a sorting device, the method comprising:
providing at least one piece of process information created as a result of manufacturing of the workpieces;
analyzing the at least one piece of process information, such that it is determined whether there is a sorting disruption; and
upon determining that there is the sorting disruption, automatically modifying the sorting process.

2. The sorting method according to claim 1, wherein the process information is provided by a monitoring sensor system of the flatbed machine tool and is transmitted to a controller of the sorting device.

3. The sorting method according to claim 1, wherein the process information is assigned to at least one workpiece of the workpieces, and the sorting disruption determined from the process information is assigned to the same workpiece.

4. The sorting method according to claim 1, wherein the method further comprises removing a workpiece, of the workpieces, from the sorting process as a result of determining the sorting disruption.

5. The sorting method according to claim 1, wherein each of the workpieces is assigned a specific disruption probability as a result of the determined sorting disruption.

6. The sorting method according to claim 5, wherein a workpiece, of the workpieces, is assigned a higher disruption probability as the number of sorting disruptions determined for this workpiece increases.

7. The sorting method according to claim 5, wherein the automatically modifying of the sorting process comprises changing a sorting sequence of the sorting process, and wherein the sorting of the workpieces is carried out according to a size of the determined disruption probabilities of the workpieces.

8. The sorting method according to claim 1, wherein the process information is provided in the form of a workpiece position, a tool distance to the workpieces, a tool state, or a method course.

9. The sorting method according to claim 1, wherein an image of a removal area of the flatbed machine tool is created and used to evaluate the process information.

10. The sorting method according to claim 9, wherein the method further comprises determining an image information from the image, and comparing the image information with the process information, wherein a position specification of the workpieces, a design of the workpieces, or a number of the workpieces is determined from the image information.

11. The sorting method according to claim 1, wherein the sorting disruption comprises a miscut, a tilting, or a displacement of the workpieces.

12. A sorting device for automatically sorting workpieces produced in a flatbed machine tool according to a scheduled sorting process, the sorting device comprising:
a gripper configured to grip the workpieces; and
a controller configured to control the gripper;
wherein the controller is configured to:
determine whether a sorting disruption has occurred by evaluating a provided piece of process information; and
automatically modifying the sorting process based upon determining that sorting disruption has occurred.

13. The sorting device according to claim 12, the sorting device further comprising an imager configured to create an image of a removal area in which the workpieces are positioned for sorting; wherein the controller is set up to determine image information from the image and to determine a sorting disruption using the image information.

14. An arrangement, the arrangement comprising:
the flatbed machine tool; and
the sorting device according to claim 12,
wherein the flatbed machine tool is configured to produce the workpieces and to position the workpieces in a removal area,
wherein the sorting device is configured to sort the workpieces positioned in the removal area according to a sorting process, and
wherein the flatbed machine tool is configured to provide the process information.

15. The arrangement according to claim 14, wherein the flatbed machine tool comprises a monitoring sensor system which is configured to transmit the process information to the controller of the sorting device.

16. The sorting method according to claim 1, wherein the flatbed machine tool is a laser cutting machine or a punching machine.
